(19) United States
(12) Patent Application Publication
(10) Pub. No.: US 2026/0002062 A1
(43) Pub. Date: Jan. 1, 2026

(54) Abrasive Apparatus having a Material with Variable Stiffness

(71) Applicant: Robert Bosch GmbH, Stuttgart (DE)

(72) Inventors: Jeremy Rubens, Palatine, IL (US); Daniel White, Bettendorf, IA (US)

(21) Appl. No.: 19/236,011

(22) Filed: Jun. 12, 2025

Related U.S. Application Data
(60) Provisional application No. 63/665,445, filed on Jun. 28, 2024.

(51) Int. Cl. C09K 3/14; B24B 23/04

(52) U.S. Cl. CPC C09K 3/14; B24B 23/046

(57) ABSTRACT

An abrasive apparatus includes a backing pad comprising a filler material having a variable stiffness material configured with a first stiffness when the abrasive apparatus is in a non-working state, and a second stiffness that is higher than the first stiffness when the abrasive apparatus is in a working state. In addition, the abrasive apparatus includes an abrasive surface connected to the backing pad.

This application claims priority to U.S. Provisional Application Ser. No. 63/665,445 entitled “Sanding Apparatus having a Shear-Thickening Material” filed Jun. 28, 2024, the disclosure of which is incorporated herein by reference in its entirety.

### FIELD

This disclosure relates generally to sanding apparatuses.

### BACKGROUND

Sanding shapes and details can be difficult. The standard method of sanding includes foam pads that conform to the shape or using several specific profiles to sand different pieces individually. However, when using a foam pad on small details, the foam pad must be sufficiently compliant that the sanding pad engages the small details. However, foam pads that are sufficiently compliant to match to the shapes of small details typically do not provide enough resistance to enable sanding in the small details. Further, the foam generally results in greater force application to the details that project outward, i.e. peaks, while a reduced force is applied to the inward details, i.e. valleys. As such, the sanding of the details is inconsistent.

What is needed, therefore, are improvements in sanding apparatuses that reduce the aforementioned deficiencies.

### SUMMARY

In one embodiment, an abrasive apparatus includes a backing pad comprising a filler material having a variable stiffness material configured with a first stiffness when the abrasive apparatus is in a non-working state, and a second stiffness that is higher than the first stiffness when the abrasive apparatus is in a working state. In addition, the abrasive apparatus includes an abrasive surface connected to the backing pad.

In some embodiments, the variable stiffness material includes a non-Newtonian material. The non-Newtonian material may be a shear-thickening foam material. In one embodiment, the shear-thickening foam material exhibits the second stiffness in response to rapid movement of the abrasive apparatus against a workpiece surface.

In further embodiments, the shear-thickening foam material exhibits the first stiffness when deformed by approximately 1 inch per second or less, and exhibits the second stiffness when deformed by approximately 2 inches per second or more.

In yet another embodiment, the shear-thickening foam material includes a foam having a non-Newtonian fluid or gel in pores of the foam.

The shear-thickening foam material may, in some embodiments, comprise a dried and solidified shear-thickening fluid or gel.

In another embodiment, the variable stiffness material is enclosed within a flexible housing. In one particular embodiment, the variable stiffness material includes a non-Newtonian fluid enclosed within the flexible housing.

In some embodiments, the variable stiffness material includes a magnetorheological fluid enclosed within the flexible housing. The abrasive apparatus may, in embodiments, further include a magnetic field generator operably connected to a battery and configured to selectively generate a magnetic field, wherein the magnetorheological fluid has the first stiffness in the absence of the magnetic field, and the second stiffness when the magnetic field generator generates the magnetic field.

Some embodiments of the abrasive apparatus further include a grip region arranged on a side of the backing pad opposite the abrasive surface.

In further embodiments, the abrasive apparatus includes an attachment arrangement configured to connect to a power tool and arranged on a side of the backing pad opposite the abrasive surface.

In another embodiment according to the disclosure, an abrasive apparatus includes a backing pad comprising a shear-thickening foam having a first stiffness when the abrasive apparatus is in a non-working state, and a second stiffness that is higher than the first stiffness when the abrasive apparatus is moved rapidly in a working state; and an abrasive surface connected to the backing pad.

In one embodiment, a power tool includes a power source, a motor operably connected to the power source and configured to impart a vibratory or oscillating motion on the power tool, an abrasive surface, and a backing pad to which the abrasive surface is connected. The backing pad includes a shear-thickening foam having a first stiffness when the abrasive apparatus is in a non-working state, and a second stiffness that is higher than the first stiffness when the motor imparts the vibratory or oscillating motion such that the abrasive surface is moved rapidly against a workpiece when the motor is in a working state.

### BRIEF DESCRIPTION OF THE DRAWINGS

FIG. 1 is a perspective view of a sanding apparatus according to the disclosure having a non-Newtonian material in the backing pad.

FIG. 2 is a perspective view of the sanding apparatus of FIG. 1 pressed into a workpiece.

FIG. 3 is a perspective view of the sanding apparatus of FIG. 1 pressed into the workpiece and being moved to perform work on the workpiece.

FIG. 4 is a perspective view of the sanding apparatus of FIG. 1 used on a power sander.

FIG. 5 is a perspective view of the sanding apparatus of FIG. 1 used on a manual sanding block.

FIG. 6 is a cross-sectional view of another embodiment of a sanding apparatus having a non-Newtonian fluid arranged within a flexible pouch or housing.

FIG. 7 is a perspective view of another embodiment of a sanding apparatus having a magnetorheological fluid arranged within a flexible pouch or housing.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

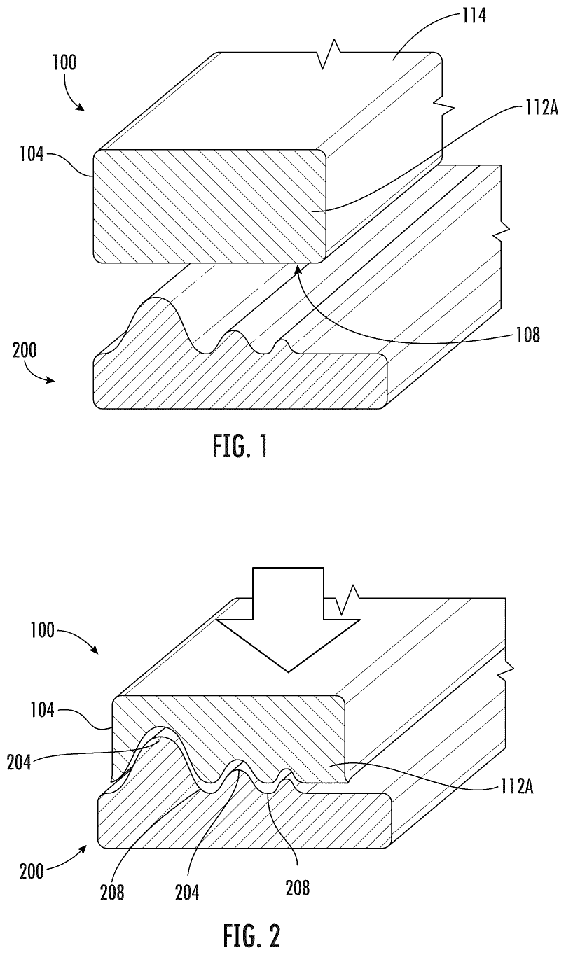

FIG. 1 depicts an abrasive tool 100 according to the disclosure having a material with variable stiffness, which may be in particular a non-Newtonian material. A non-Newtonian material is a material in which the resistance to motion or compression of the material changes as a function of force applied to the material. In the abrasive tool 100, the non-Newtonian material is compliant to match profiles and contours of a workpiece on which the abrasive tool 100 is used, but becomes stiff or resistant to compression when the material is subjected to compressive or shear force such as, for example, during rapid movements of the abrasive tool 100 against a workpiece. The abrasive tool 100 may be, for example, a sanding tool, a polishing tool, a grinding tool, or the like. The abrasive tool 100 includes a backing pad 104 and an abrasive surface 108. The abrasive surface 108 may include, for example, any desired working surface, for example, sandpaper, a polishing material, a grinding material, and the like.

The backing pad 104 is formed, at least partially, of a variable stiffness filler material, for example a shear-thickening material 112A. A variable stiffness material is a material that has a resistance to deformation, and in particular to compression, that varies as a function of an input variable, which may be for example shear stress or compressive force applied to the material, electrical energy applied to the material, or magnetic field applied to the material. In particular, the variable stiffness material has a first stiffness in the non-working state of the abrasive tool 100, and a second stiffness that is greater than the first stiffness in the working state of the abrasive tool 100. A shear-thickening, or dilatant, material is a material that is relatively soft and pliable in its normal state. However, when shear force is applied to the shear-thickening material over a relatively short time frame, the material stiffens and resists further deformation. In particular, the shear-thickening material is configured such that, when shear force is applied quickly, the rigidity of the material increases such that the backing pad 104 retains its shape. Thus, when force is applied over a relatively long timeframe to the backing pad 104 in a non-working state, the backing pad 104 has a first stiffness that is relatively soft and deformable, but when shear force is applied over a short time frame to the backing pad 104 in the working state of the abrasive tool 100, the material has a second greater stiffness and behaves more like a solid.

The shear-thickening material may be a shear-thickening foam material, which may include an open-cell or closed-cell foam material impregnated with a non-Newtonian fluid or gel in the pores of the foam. In another embodiment, the shear-thickening foam may be formed by a dried and solidified non-Newtonian or shear-thickening fluid or gel that has air bubbles trapped within the solidified non-Newtonian material.

For example, the shear-thickening fluid may be formed of a fluid phase component and a solid phase component comprising particles suspended in the fluid phase component. The fluid phase component may be, for example, water, ethylene glycol, polyethylene glycol, alcohol, ionic liquids, mineral oil, or another suitable liquid. The solid particles may be, for example, carbon or silica nanoparticles, polymethyl methacrylate, polystyrene-ethylacrylate calcium carbonate, cornstarch, synthetically and naturally occurring minerals, polymers, and the like.

When stress is applied relatively quickly to the shear-thickening fluid in a working state, the solid particles within the foam begin to interact with each other and with the surrounding fluid phase component. These interactions cause the particles to form temporary networks or structures that resist deformation and flow. As a result, the foam becomes thicker and more solid-like under application of rapid stress, exhibiting shear thickening behavior.

On a side of the backing pad 104 opposite the abrasive surface 108, the abrasive tool 100 includes a grip region 114. The grip region 114 may be formed of a rigid material to facilitate a user gripping the abrasive tool 100 to manually sand a workpiece. Alternatively, the grip region 114 may be formed of a compliant material such that the user can grip the non-Newtonian shear-thickening material, and the shear-thickening material conforms to the user's hand to facilitate a particularly ergonomic grip. Once the user begins to apply force to the abrasive tool 100 in the working state of the abrasive tool 100, the grip region 114 hardens, thereby enabling the user to apply the sanding motion to the abrasive tool 100.

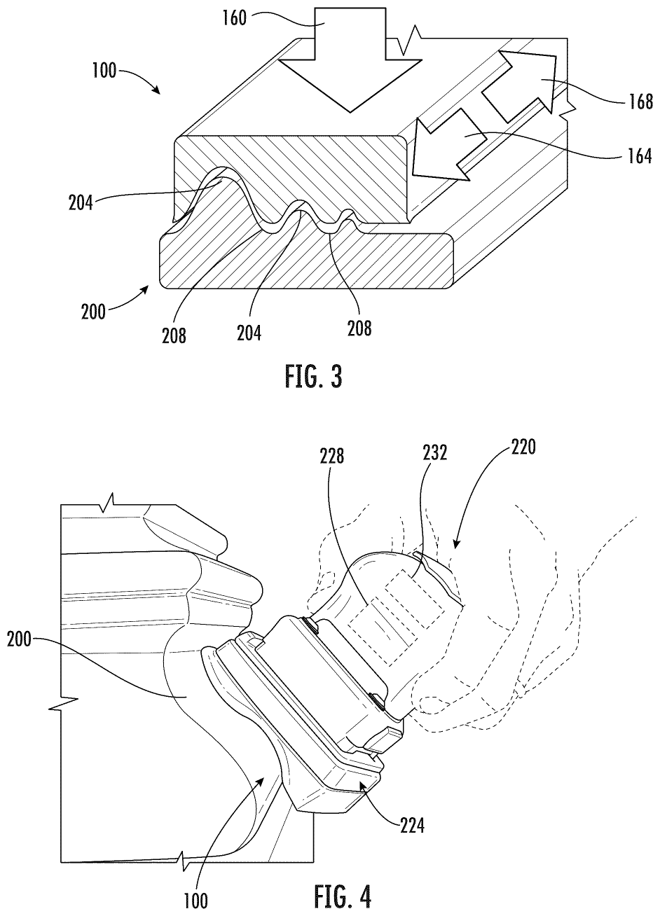

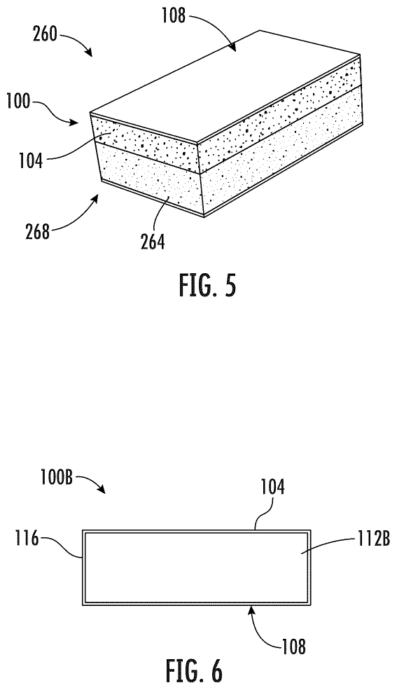

In other embodiments, the side of the backing pad 104 opposite the abrasive surface 108 may be configured to attach to a separate handle or block (e.g. FIG. 5) or to a powered sanding tool (e.g. FIG. 4). In such a configuration, the side of the backing pad 104 opposite the abrasive surface 108 may include a connection surface, for example a hook and loop connection surface, or a positive connecting structure such as, for example, a hook or clip arrangement.

To use the abrasive tool 100, the user applies a force 160 relatively slowly, for example causing deformation on the order of approximately 1 inch per second or less, to the back of the backing pad 104 to press the abrasive surface 108 against a workpiece 200 while the abrasive tool 100 is not in the working state (see FIG. 2). Since the force 160 is applied generally toward the workpiece, the backing pad 104 is subjected to a limited shear stress rate. As such, the shear-thickening material is in a soft state, which enables the backing pad 104 and the attached abrasive surface 108 to conform to the shape of the workpiece 200 by deforming a greater amount in the peaks 204 of the workpiece 200 and deforming by a lesser amount in the valleys 208 of the workpiece 200.

Next, the user begins working with the abrasive tool 100 by moving it relatively rapidly laterally, for example causing deformation on the order of approximately 2 inches per second or more, in directions 164 and 168, along the surface of the workpiece 200 in a working state (see FIG. 3). The relatively rapid movement of the abrasive tool 100 while it is in contact with the workpiece 200 causes increased shear stresses within the shear-thickening material of the backing pad 104, resulting in the shear-thickening material becoming more rigid. As such, the abrasive surface 108 presses into the workpiece 200 with increased force since the backing pad 104 is no longer compliant. The abrasive surface 108, along with the backing pad 104, therefore maintains its conformance with the shape of the workpiece 200, while being sufficiently stiff that the abrasive surface 108 abrades the surface of the workpiece 200. Consequently, due to the conformance of the backing pad 104, the abrasive tool 100 abrades the entire surface of the workpiece 200, including both the peaks 204 and the valleys 208, generally equally.

In one embodiment, illustrated in FIG. 4, the abrasive tool 100 is configured to connect to a power tool 220, for example a power sander such as an orbital sander or a sheet sander, via an attachment arrangement 224 such as a hook and loop structure or a clamping mechanism. The power tool 220 includes a motor 228 operably connected to a power source 232 (e.g., a mains connection or a battery) and configured to impart vibratory or oscillating movement on the power tool 220 in a working state to move the abrasive tool 100 to be moved laterally faster than a hand sanding block, thereby further exaggerating the shear-thickening behavior of the backing pad 104. As a result, the abrasive tool 100 attains a higher degree of rigidity when the power tool 220 is active, increasing the abrasion of the work surface and/or reducing the force that must be exerted by the user to press the abrasive tool 100 into the workpiece 200.

In another embodiment, depicted in FIG. 5, the abrasive tool 100 is part of a sanding block 260. The sanding block includes a main body 264, which may include a handle or grip portion 268 configured to enable the user to firmly grip the sanding block 260. The abrasive tool 100 may be configured to removably connect to the main body 264 to enable the abrasive tool 100 to be replaced.

Alternatively, in some embodiments, the abrasive tool 100 is permanently affixed to the main body 264, while the abrasive surface 108 may be replaceable. In other embodiments, the abrasive tool 100 is permanently affixed to the main body 264, and the abrasive surface 108 is not replaceable. Additionally or alternatively, the backing pad 104 may be configured as the grip portion, and the sanding block therefore does not include a main body. For example, the sanding block may be configured similar to a conventional foam sanding block, but with shear thickening foam in place of a conventional open cell foam. Further additionally or alternatively, the sanding block may include abrasive surfaces on two, four, six, or any desired number of sides.

In another embodiment, shown in FIG. 6, the variable stiffness material of an abrasive tool 100B may be a shear-thickening non-Newtonian fluid 112B enclosed within a flexible pouch or housing 116. As discussed in detail above, the shear-thickening fluid is flowable in the absence of shear force, and has increased viscosity and therefore reduced flowability when shear stress is applied in the working state. In the abrasive tool 100B, the shear-thickening fluid 112B functions similarly to the embodiment described above, allowing the flexible pouch or housing 116 to deform to conform to the shape of a workpiece when moved relatively slowly. When the sanding apparatus is moved quickly, however, the viscosity of the shear thickening fluid 112B increases, thereby increasing the rigidity of the backing pad 104 and enabling the abrasive tool 100B to abrade within the details of the workpiece. As such, the abrasive tool 100B achieves similar advantages as the embodiments described above

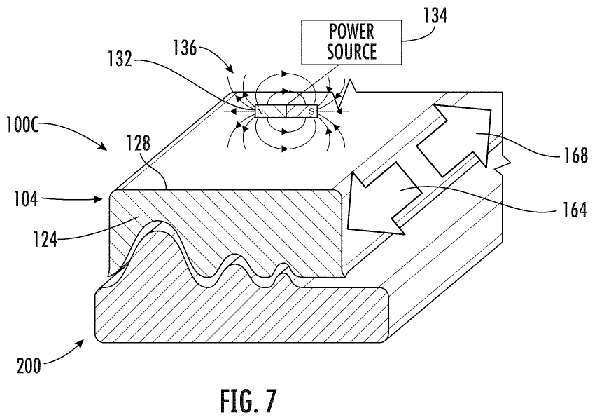

In yet another embodiment, depicted in FIG. 7, the variable stiffness material of an abrasive tool 100C includes a magnetorheological (MR) fluid 124 filled in a flexible pouch or housing 128 to achieve the variable stiffness abrasive tool 100C. The MR fluid 124 includes a carrier fluid and microscopic magnetic particles suspended in the carrier fluid. In the absence of a magnetic field, the microscopic magnetic particles are disorganized and spread throughout the carrier fluid. However, when a magnetic field is applied to the MR fluid 124, i.e. transitioning the abrasive tool 100C into the working state, the microscopic magnetic particles align with the direction of the magnetic flux, causing the microscopic magnetic particles, and thereby the MR fluid 124 as a whole, to resist deformation.

The abrasive tool 100C further includes a magnetic field generator 132 that produces a magnetic field 136 acting on the MR fluid. In particular the magnetic field generator 132 may be an electromagnet, an inductive coil, or the like. The magnetic field generator 132 is operably connected to a power source, for example a battery 134, and is activated by the user via, for example, a button or switch (not shown) to selectively activate and deactivate the magnetic field 136 to transition the abrasive tool 100C between the working and non-working states. When the magnetic field generator 132 is inactive, the MR fluid 124 has a low viscosity, and the backing pad 104 is therefore flexible to enable the backing pad 104 and the abrasive surface 108 to conform to the shape of the workpiece 200. Once the abrasive tool 100C is situated, the user activates the magnetic field generator 132 to generate the magnetic field 136, causing the MR fluid 124 to respond by increasing in viscosity. The backing pad 104 then increases in rigidity while in conformance with the surface of the workpiece 200, thereby allowing the motion of the abrasive tool 100 to abrade the workpiece 200 substantially evenly.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. An abrasive apparatus comprising:
a backing pad comprising a filler material having a variable stiffness material configured with a first stiffness when the abrasive apparatus is in a non-working state, and a second stiffness that is higher than the first stiffness when the abrasive apparatus is in a working state; and
an abrasive surface connected to the backing pad.

2. The abrasive apparatus of claim 1, wherein the variable stiffness material includes a non-Newtonian material.

3. The abrasive apparatus of claim 2, wherein the non-Newtonian material is a shear-thickening foam material.

4. The abrasive apparatus of claim 3, wherein the shear-thickening foam material exhibits the second stiffness in response to rapid movement of the abrasive apparatus against a workpiece surface.

5. The abrasive apparatus of claim 4, wherein the shear-thickening foam material exhibits the first stiffness when deformed by approximately 1 inch per second or less, and exhibits the second stiffness when deformed by approximately 2 inches per second or more.

6. The abrasive apparatus of claim 4, wherein the shear-thickening foam material includes a foam having a non-Newtonian fluid or gel in pores of the foam.

7. The abrasive apparatus of claim 4, wherein the shear-thickening foam material comprising a dried and solidified shear-thickening fluid or gel.

8. The abrasive apparatus of claim 1, wherein the variable stiffness material is enclosed within a flexible housing.

9. The abrasive apparatus of claim 8, wherein the variable stiffness material includes a non-Newtonian fluid enclosed within the flexible housing.

10. The abrasive apparatus of claim 8, wherein the variable stiffness material includes a magnetorheological fluid enclosed within the flexible housing.

11. The abrasive apparatus of claim 10, further comprising:
a magnetic field generator operably connected to a battery and configured to selectively generate a magnetic field,
wherein the magnetorheological fluid has the first stiffness in the absence of the magnetic field, and the second stiffness when the magnetic field generator generates the magnetic field.

12. The abrasive apparatus of claim 1, further comprising a grip region arranged on a side of the backing pad opposite the abrasive surface.

13. The abrasive apparatus of claim 1, further comprising an attachment arrangement configured to connect to a power tool and arranged on a side of the backing pad opposite the abrasive surface.

14. An abrasive apparatus comprising:
a backing pad comprising a shear-thickening foam having a first stiffness when the abrasive apparatus is in a non-working state, and a second stiffness that is higher than the first stiffness when the abrasive apparatus is moved rapidly in a working state; and
an abrasive surface connected to the backing pad.

15. A power tool comprising:
a power source;
a motor operably connected to the power source and configured to impart a vibratory or oscillating motion on the power tool;
an abrasive surface; and
a backing pad to which the abrasive surface is connected, the backing pad comprising a shear-thickening foam having a first stiffness when the power tool is in a non-working state, and a second stiffness that is higher than the first stiffness when the motor imparts the vibratory or oscillating motion such that the abrasive surface is moved rapidly against a workpiece when the motor is in a working state.
